(19) United States
(12) Patent Application Publication
(10) Pub. No.: US 2019/0040768 A1
(43) Pub. Date: Feb. 7, 2019

(54) CAMSHAFT ASSEMBLY

(71) Applicant: GM GLOBAL TECHNOLOGY OPERATIONS LLC, DETROIT, MI (US)

(72) Inventors: Blaise R. Didonato, Commerce Township, MI (US); Joseph J. Moon, Beverly Hills, MI (US); Mark Stabinsky, Troy, MI (US); Domenic Certo, Niagara Falls (CA)

(21) Appl. No.: 15/665,737

(22) Filed: Aug. 1, 2017

(51) Int. Cl. F01L 1/053; F01L 1/344; F01L 1/047; F01L 1/26

(52) U.S. Cl. CPC F01L 1/0532; F01L 1/34413; F02D 13/0211; F01L 1/262; F01L 1/3442; F01L 1/047

(57) ABSTRACT

A camshaft assembly for a vehicle engine includes a camshaft member, a cam phaser and a cam nose. The camshaft member includes a front end and a rear end. The camshaft member may be configured to actuate at least one intake valve of a combustion chamber. The cam phaser affixed to the front end of the camshaft member while the cam nose may be disposed at the front end of the camshaft. The cam nose further includes a cam nose face with a curvilinear groove surrounding a central axis region of the cam nose. The curvilinear groove may be configured to engage with the cam phaser to prevent oil leakage out from the central axis region and/or to rotationally lock the cam phaser to the camshaft member.

### TECHNICAL FIELD

The present disclosure relates to a camshaft assembly for a vehicle engine.

### INTRODUCTION

Vehicles typically include an engine assembly for propulsion. The engine assembly may include an internal combustion engine defining one or more cylinders. In addition, the engine assembly may include intake valves for controlling the inlet charge into the cylinders and exhaust valves for controlling the flow of exhaust gases out of the cylinders. The engine assembly may further include a valve train system for controlling the operation of the intake and exhaust valves. The valve train system includes a camshaft for moving the intake and exhaust valves.

The rotation of the camshaft assembly (and movement of the valve train system) is coordinated with the crankshaft, crankshaft sprocket, timing belt/chain and camshaft sprocket. Cam phasing advances or retards valve lift events by rotating the camshaft via rotor in the cam phaser. The camshaft assembly may be rotated over a range of about 25-40 cam degrees relative to the crankshaft angle. Retarding valve timing causes the valve to open and close later and advancing valve timing causes valve to open and close earlier. Optimal valve timing for engine performance and fuel economy are controlled by advancing or retarding the cam phasing system.

In general, an ECU may receive data signals from the accelerator pedal position, camshaft position sensor, crankshaft sensor, oil temperature sensor, mass air flow sensor, and the engine coolant temperature sensor and uses the information to adjust its output signal to an oil control valve. The oil control valve acts as a hydraulic actuator, rotating a rotor (which is connected to the camshaft) inside a housing. The camshaft assembly is connected to the crankshaft via a timing chain.

Once the ECU has changed the cam phase angle, the ECU continues to receive inputs from all of the sensors and continually adjusts the oil feed to the rotor. This is a dosed loop system which means that the difference between the current camshaft phase angle and the optimal camshaft angle is the “error signal” that is sent to the ECU. The ECU uses the error signal to adjust its output to the actuator to get the camshaft phase angle where it needs to be.

The engine performance may be very sensitive to torque loads applied to the cam shaft via the rotor given that such torque loads enable an angular change in the camshaft. A slip condition may occur at the joint between the cam phaser and the camshaft member where undesirable movement may occur between the cam phaser and the camshaft member as the cam phaser torques the camshaft member. Moreover, oil has been known to unintentionally leak out from the joint between the cam phaser and camshaft member which drops the oil pressure in the cam phaser and cause slow phasing response or cause stability issues.

Accordingly, to optimize the efficiency of the torque loads while maintaining the oil pressure in the cam phaser (which may be driven by a hydraulic oil valve), there is a need to have the cam nose which is disposed at the end of the camshaft assembly (adjacent to cam phaser) to rotate in unison with the cam phaser while also preventing undesirable oil leakage between the output gear and the cam nose.

### SUMMARY

A camshaft assembly for a vehicle engine significantly reduces the risk of slip occurring between the cam phaser and the camshaft member while also preventing oil from leaking out of the central axis region of the camshaft member/camnose. The camshaft assembly includes a camshaft member, a cam phaser and a cam nose. The camshaft member includes a front end and a rear end. The camshaft member may be configured to actuate at least one intake valve of a combustion chamber. The cam phaser affixed to the front end of the camshaft member while the cam nose may be disposed at the front end of the camshaft. The cam nose further includes a cam nose face with an etched curvilinear groove surrounding a central axis region of the cam nose. The curvilinear groove may be configured to engage with the cam phaser to prevent oil leakage out from the central axis region and/or to rotationally lock the cam phaser to the camshaft member.

The cam phaser may further include an input gear and an output gear wherein the output gear is configured to drive the rotation of the camshaft member via at least an engagement between the cam phaser and the curvilinear groove and a plurality of peripheral grooves. The output gear may be rotatably supported by the input gear. Upon engagement between the output gear face (or cam phaser face) and the cam nose, the output gear face/cam phaser face may deform upon engagement with the etched curvilinear groove. The curvilinear groove further includes a curvilinear valley and a curvilinear protrusion formed on each side of the curvilinear valley. The curvilinear protrusion on each side of the curvilinear valley deforms the cam phaser face upon engagement between the cam phaser face and the cam nose face. It is understood that the curvilinear groove is configured to seal oil within the central axis region of the cam nose face upon engagement with the cam phaser face. A plurality of peripheral grooves defined on the cam nose are configured to rotationally lock the cam phaser to the cam nose. Similar to the curvilinear groove, the plurality of peripheral grooves are configured to also deform the cam phaser upon engagement between the cam nose and the cam phaser.

In yet another embodiment of the present disclosure, a camshaft is provided which is adapted to engage with any one of a variety of cam phasers. The camshaft includes a camshaft member, a cam nose, a plurality of lobes and plurality of journals. The camshaft member includes a front end and a rear end. The cam nose may be disposed at the front end of the camshaft member and adapted to engage with a cam phaser. It is understood that the cam nose may define a curvilinear groove which surrounds a central axis region of the cam nose and seals oil within the central axis region. The plurality of lobes may be disposed on the camshaft member between the front end and the rear end.

Similar to the embodiment of the camshaft assembly, the camshaft also provides a curvilinear groove etched or defined in the cam nose wherein upon engagement between the output gear face of a cam phaser (or cam phaser face) and the cam nose, the output gear face/cam phaser face may deform upon engagement with the etched curvilinear groove. The curvilinear groove also further includes a curvilinear valley and a curvilinear protrusion formed on each side of the curvilinear valley. The curvilinear protrusion on each side of the curvilinear valley deforms the cam phaser face upon engagement between the cam phaser face and the cam nose face. Likewise, it is understood that the curvilinear groove of the camshaft is configured to seal oil within the central axis region of the cam nose face upon engagement with a cam phaser. A plurality of peripheral grooves defined on the cam nose are also configured to rotationally lock the cam phaser to the cam nose. Similar to the curvilinear groove, the plurality of peripheral grooves are configured to also deform the cam phaser upon engagement between the cam nose and the cam phaser.

### BRIEF DESCRIPTION OF THE DRAWINGS

FIG. 1 illustrates an example, non-limiting powertrain system in accordance with the present disclosure,

FIG. 2 illustrates an isometric view of a camshaft assembly in accordance with the present disclosure.

FIG. 3 illustrates a side cross-sectional view of the camshaft assembly of FIG.

FIG. 4 illustrates an isometric view of a camshaft in accordance with the present disclosure.

FIG. 5 illustrates an example, non-limiting curvilinear groove and example a plurality of peripheral grooves defined on the cam nose in accordance with the present disclosure.

FIG. 6A illustrates an example, enlarged cross sectional view of he curvilinear groove.

FIG. 6B illustrates an example, enlarged cross-sectional view of the engagement between the cam nose groove(s) and the cam phaser.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any manner.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

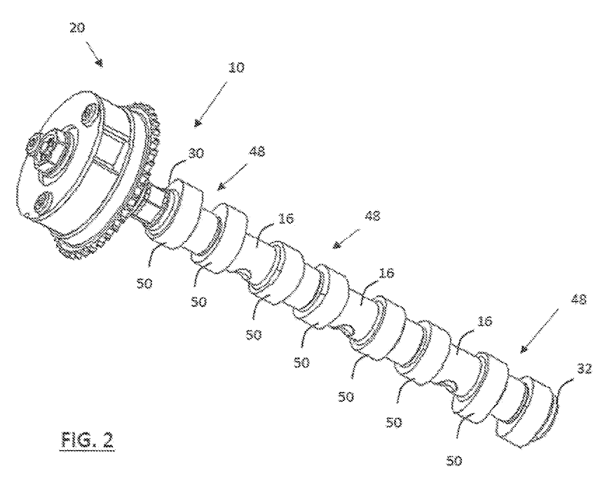

The internal combustion engine 114 of powertrain system 110 includes an engine block 118 defining a plurality of cylinders 120A, 120B, 120C, 120D. In other words, the engine block 118 includes a first cylinder 120A, a second cylinder 120B, a third cylinder 120C, and a fourth cylinder 120D. Although FIG. 2 schematically illustrates four cylinders, the internal combustion engine 114 may include fewer or more cylinders. The cylinders are spaced apart from each other but may be substantially aligned along an engine axis E. Each of the pistons is configured to reciprocate within each corresponding cylinder 120A, 1203, 1200. and 120D. Each cylinder 120A, 120B, 120C, 120D defines a corresponding combustion chamber 122A, 1223, 122C. During the operation of the internal combustion engine 114, an air/fuel mixture is combusted inside the combustion chambers 122A, 1223, 11220, 122D in order to drive the pistons in a reciprocating manner. The reciprocating motion of the pistons drive a crankshaft (not shown) operatively connected to the wheel (not shown) of the vehicle. The rotation of the crankshaft can cause the wheels to rotate, thereby propelling the vehicle.

In order to propel the vehicle, an air fuel mixture should be introduced into the combustion chambers. To do so, the internal combustion engine 114 includes a plurality of intake port fluidly coupled to an intake manifold (not shown). In the depicted embodiment, the internal combustion engine 114 includes two intake ports 124 in fluid communication with each combustion chamber 122A, 1223, 122C, 122D.

The internal combustion engine 114 further includes a plurality of intake valves 126 configured to control the flow of inlet charge through the intake ports 124. The number of intake valves 126 which corresponds to the number of intake ports 124. Each intake valve 126 is at least partially disposed within a corresponding intake port 124. In particular, each intake valve 126 is configured to move along the corresponding intake port 124 between an open position and a closed position. In the open position, the intake valve 126 allows inlet charge to enter a corresponding combustion chamber 122A, 1228, 122C, 122D via the corresponding intake port 124. Conversely, in the closed position, the intake valve 126 precludes the inlet charge from entering the corresponding combustion chamber 122A, 122B, 122C, or 122D via the intake port 124.

As discussed above, the internal combustion engine 114 can combust the air/fuel mixture once the air/fuel mixture enters the combustion chamber 122A, 122B, 122C, or 122D. For example, the internal combustion engine 114 can combust the air/fuel mixture in the combustion chamber 122A, 122B, 122C, 122D using an ignition system (not shown). This combustion generates exhaust gases. To expel these exhaust gases, the internal combustion engine 114 defines a plurality of exhaust ports 128. The exhaust ports 128 are in fluid communication with the combustion chambers 122A, 122B, 122C, 1221. In the depicted embodiment, two exhaust ports 128 for each combustion chamber 122A, 122B, 122C, 122D are in fluid communication with each combustion chamber 122A, 122B, 122C, 122D. However, more or fewer exhaust ports 128 may be fluidly coupled to each combustion chamber 122A, 122B, 122C, 122D. The internal combustion chamber includes at least one exhaust port per cylinder 120A, 120B, 120C, 120D.

The internal combustion engine 114 further includes a plurality of exhaust valves 130 in fluid communication with the combustion chambers 122A, 122B, 122C, 122D. Each exhaust valve 130 is at least partially disposed within a corresponding exhaust port 128. In particular, each exhaust valve 130 is configured to move along the corresponding exhaust port 128 between an open position and a closed position. In the open position, the exhaust valve 130 allows the exhaust gases to escape the corresponding combustion chamber 122A, 122B, 122C, 122D via the corresponding exhaust port 128. In particular, each exhaust valve 130 is configured to move along the corresponding exhaust port 128 between an open position and a closed position. In the open position, the exhaust valve 130 allows the exhaust gases to escape the corresponding combustion chamber 122A, 122B, 122C, 122D via the corresponding exhaust port.

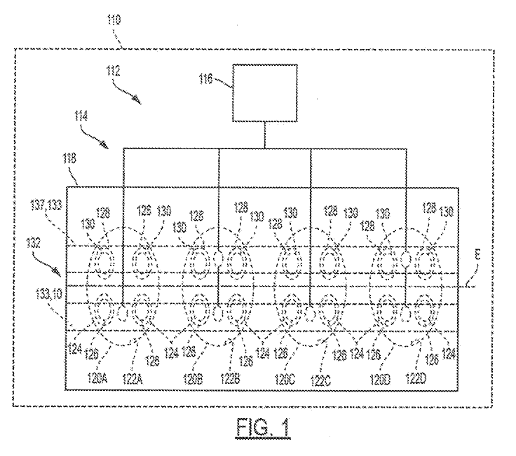

The intake valve 126 and exhaust valve 130 can also be generally referred to as engine valves. Each valve 126, 130 is operatively coupled or associated with a cylinder 120A, 120B, 120C, 120D. Each valve (the intake valve 126 and the exhaust valve 130 in FIG. 1) is configured to control fluid flow (i.e. air/fuel mixture for intake valves 126 and exhaust gas valve 130) to the corresponding cylinder 120A, 120B, 120C, 120D.

As shown, the engine assembly 12 includes a valve train system 132 configured to control the operation of the intake valves 126 and exhaust valves 130. Specifically, the valve train system 132 can move the intake valves 126 and exhaust valves 130 between the open and closed positions as dictated by the ECU 16 and based at least in part on the operating conditions of the internal combustion engine 114 (e.g., engine speed). The valve train system 132 includes one or more camshafts 133 substantially parallel to the engine axis E along with the associated cams on each camshaft. The intake camshaft assembly 10 is configured to control the operation of the intake valves 126, and the exhaust camshaft 137 can control the operation of the exhaust valves 130. It is contemplated, however, that the valve train system 132 may include more or fewer camshafts 133.

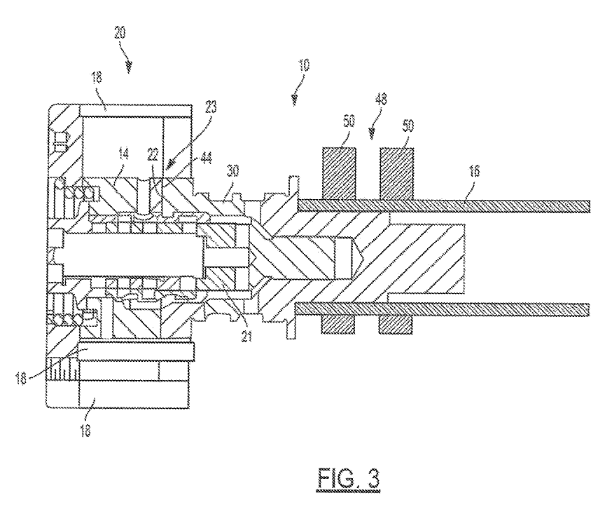

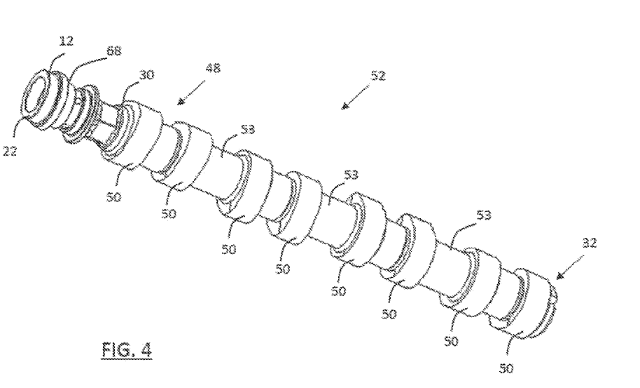

Referring now to FIGS. 2 and 3, an isometric view of an example, non-limiting camshaft assembly 10 is shown in FIG. 2 while FIG. 3 illustrates a cross-sectional view of the camshaft assembly 10 of FIG. 2. As shown, an example non-limiting camshaft assembly 10 of the present disclosure is provided for use in a vehicle engine. The camshaft assembly 10 includes a camshaft member 16, a cam phaser 20 and a cam nose 12. Cam nose 12 may be a feature which is machined directly into the front end 30′ (FIG. 3) of camshaft member 16 as shown in FIG. 3 wherein cam nose 12 and camshaft member 16 are a unitary member. Cam shaft member 16 may also include journals 53. As shown the plurality 55 of journals are disposed on the cam shaft member 16. Alternatively, cam nose 12 may be formed as a feature on end cap member 68 (FIGS. 2 and 4) which may be press-fitted onto the front end 30 of camshaft member 16. The camshaft member 16 may include a front end 30 (FIG. 3) and a rear end 32 (FIGS. 2 and 4). Center bolt 21 affixes the Cam nose 12 to the output gear 14 at the joint 23 between the cam phaser 20 and camshaft member 18. As noted, the camshaft member 16 is configured to actuate at least one intake valve of a combustion chamber via a lobe 50 disposed on the camshaft member 16. The cam phaser 20 may be affixed to the front end 30 of the camshaft member 16.

Therefore, as indicated, the cam phaser 20 is configured to adjust the angular position of the lobes 50 on the camshaft member 16. As shown, the cam nose 12 disposed at the front end 30 of the camshaft member 16. The cam nose 12 defines a cam nose face 22 which faces/abuts the cam phaser 20. The cam nose face 22 defines an etched curvilinear groove 24 which surrounds a central axis region 26 of the cam nose 12. The curvilinear groove 24 is configured to engage with the cam phaser 20 (cam phaser 20 face) thereby preventing oil 34 from leaking out from the central axis region 26 and out of the joint between the cam phaser 20 and the cam nose 12.

Upon actuation from the Engine Control Unit (element 116 in FIG. 1), the cam phaser 20 may drive the angular rotation of the lobes 50 to retard or advance the actuation of the intake valves. In order to do so, the cam phaser 20 includes an input gear 18 and an output gear 14 wherein the output gear 14 is configured to drive the angular rotation of the camshaft. It is also understood that the engagement between the curvilinear groove 24 and the cam phaser 20 enable the cam phaser 20 to be rotationally locked with the cam nose 12/camshaft member 16 via the increased effective coefficients of static and kinetic friction. Accordingly, a risk of a slip condition at joint 23 (FIG. 3) is significantly reduced. Together with center bolt 21, the cam phaser 20 and the camshaft member may rotate in complete unison. Thus, the rotation of the camshaft member 16 may be driven by the rotation of the cam phaser 20 (output gear 14 and center bolt 21 of the cam phaser 20). As shown in FIG. 3, the output gear 14 is rotatable supported by the input gear 18 which is, in turn, in communication with the ECU. In the example shown in FIG. 3, the output gear 14 of the cam phaser 20 is disposed adjacent to the cam nose 12 and therefore, the output gear 14 face may deform upon engagement with the etched curvilinear groove 24 thereby sealing oil 34 within the central axis region 26.

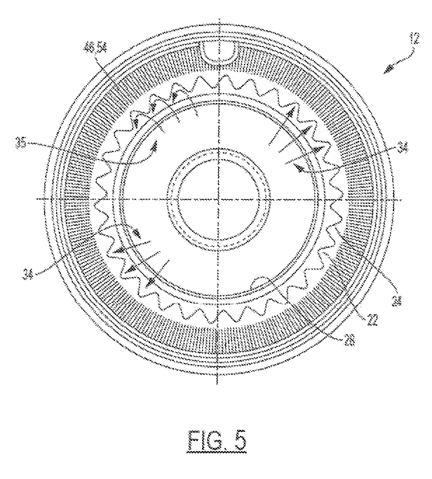

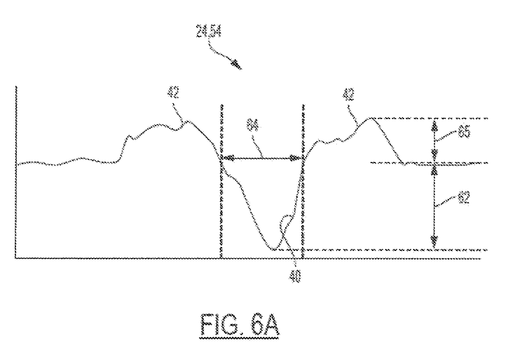

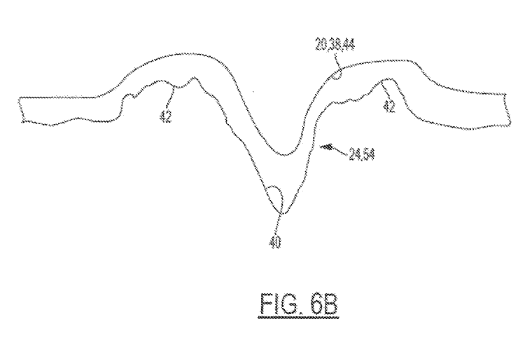

As further shown in FIG. 6A, an enlarged, example cross-section of the curvilinear groove 24 is shown wherein the curvilinear groove 24 includes a curvilinear valley 40 and a curvilinear protrusion 42 formed on each side of the curvilinear valley 40. The curvilinear protrusion 42 on each side of the curvilinear valley 40 protrudes from the surface of the cam nose 12 and therefore, may deforms the cam phaser face 44 (or surface of cam phaser) upon engagement between the cam phaser face 44 and the cam nose face 22. The engagement between the curvilinear protrusions 42/valley 40 and the cam phaser 20 creates a seal which prevents oil 34 (FIG. 5) from leaving the central axis region 26. Referring now to FIG. 5, the cam nose 12 may defines a plurality of peripheral grooves 46 disposed outside of the curvilinear groove 24. Like the curvilinear groove 24, the plurality of peripheral grooves 46 are configured to rotationally lock the cam phaser 20 to the cam nose 12 by deforming the cam phaser 20 upon engagement between the cam nose 12 and the cam phaser 20.

In yet another embodiment of the present disclosure, a camshaft 52 for a vehicle engine is shown in FIG. 4 wherein the camshaft 52 may be adapted to engage with a cam phaser 20. The camshaft 52 includes a camshaft member 16, a cam nose 12 and a plurality of lobes 48 as well as journals 53. The camshaft member 16 includes a front end 30 and a rear end 32 when the cam nose 12 may be disposed at the front end 30 of the camshaft member 16 and adapted to engage with a cam phaser 20. However, where cam nose 12 is integral to the cam shaft member 16 wherein the cam nose 12 is a feature which is machined into camshaft member, then the camshaft member 16 includes front end 30′ and rear end 32. Regardless, the cam nose 12 may define a curvilinear groove 24 which surrounds a central axis region 26 of the cam nose 12 on a cam nose face 22. The plurality of lobes 48 may be disposed on the camshaft member 16 between the front end 30 and the rear end 32. The plurality of lobes 48 are configured to engage and actuate intake valves for a combustion engine.

It is understood that curvilinear groove 24 (shown in FIG. 5) of the camshaft 52 is configured to prevent oil 34 from leaking away from the central axis upon the engagement of the cam nose 12 with the cam phaser 20. As shown in FIG. 5, curvilinear groove 24 has a non-linear configuration which upon contact with oil 34 (from the cam phaser 20 at the joint 23) directs/deflects the oil 34 as redistributed oil 35 back towards the central axis region 26. The example of the curvilinear groove 24 is shown as a wave form in FIG. 5, but it is understood that curvilinear groove 24 may take other forms. As is known, upon rotation of the camshaft 52, oil 34 tends to flow outward due to the centrifugal (rotational) forces. However, the non-linear configuration of the curvilinear groove 24 as well as the profile of the groove enables the redirection of the oil 34 as redistributed oil 35 so that oil 34, 35 does not leak out of joint 23 and therefore, the oil pressure in the cam phaser 20 does not drop and the cam phaser 20 operates at the desired performance level. Cam phasers 20 are generally known to be hydraulically driven via oil and valve. Therefore, it is desirable to maintain the oil pressure at the cam phaser 20 and prevent oil 34 (FIG. 5) from leaking out at joint 23 (FIG. 3).

As shown in FIG. 6A, the curvilinear groove 24 may further includes a curvilinear valley 40 and a curvilinear protrusion 42 formed on each side of the curvilinear valley 40. The curvilinear groove 24 and/or peripheral groove 54 may each have a depth 62 which falls in a range of about 3 μm to about 15 μm. Moreover, the curvilinear groove 24 and/or peripheral groove 54 may each have a width 64 (FIG. 6A) which falls in the range of about 0.25 mm to about 0.75 mm. The height 65 of each protrusion 42 may, but not necessarily, fall in the range of about 3 μm to about 15 μm. The curvilinear groove 24 and/or peripheral groove 54 may, but not necessarily, be laser etched onto the cam nose 12.

The curvilinear protrusion 42 on each side of the curvilinear valley 40 is adapted to deform the cam phaser 20 upon engagement between the cam phaser 20 and the cam nose 12. While FIG. 6 shows an enlarged cross-section of the curvilinear groove 24 and/or peripheral groove 54 defined on a cam nose face 22 of the cam nose 12, the curvilinear groove 24 and/or peripheral groove 54 may be defined on any surface of the cam nose 12 which abuts the cam phaser 20. Regardless, the curvilinear groove 24 surrounds the central axis region 26 of the cam nose 12. The central axis region 26 is bound by the inner wall 28 (FIG. 5) of the camshaft member 16. Similar to the camshaft assembly 10, the cam nose 12 of a camshaft of the present disclosure may define a plurality 46 of peripheral grooves 54 disposed outside of the curvilinear groove 24. The plurality 46 of peripheral grooves 54 as well as the curvilinear groove 24 are configured to rotationally lock the cam nose 12 to a cam phaser 20 by significantly increasing the effective coefficient of kinetic and static friction between the cam nose 12 to a cam phaser 20. As shown in FIG. 6B, the plurality 46 of peripheral grooves 54 may also similarly, but not necessarily, deform the cam phaser 20 upon engagement between the cam nose 12 and the cam phaser 20.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A camshaft assembly for a vehicle engine, the camshaft assembly comprising:
a camshaft member having a front end and a rear end, the camshaft member configured to actuate at least one intake valve of a combustion chamber;
a cam phaser affixed to the front end of the camshaft member; and
a cam nose disposed at the front end of the camshaft member, the cam nose having a cam nose face with an curvilinear groove surrounding a central axis region of the cam nose and configured to engage with the cam phaser and prevent oil leakage out from the central axis region.

2. The camshaft assembly as defined in claim 1 wherein the cam phaser further comprises an input gear and an output gear wherein the output gear is configured to drive the rotation of the camshaft member via at least an engagement between the cam phaser and the curvilinear groove.

3. The camshaft assembly as defined in claim 2 wherein the output gear is rotatably supported by the input gear.

4. The camshaft assembly as defined in claim 3 wherein the output gear face deforms upon engagement with the curvilinear groove.

5. The camshaft assembly as defined in claim 4 wherein the curvilinear groove further includes a curvilinear valley and a curvilinear protrusion formed on each side of the curvilinear valley.

6. The camshaft assembly as defined in claim 5 wherein the curvilinear protrusion on each side of the curvilinear valley deforms the cam phaser face upon engagement between the cam phaser face and the cam nose face.

7. The camshaft assembly as defined in claim 6 wherein the curvilinear groove is configured to seal oil within the central axis region of the cam nose face upon engagement with the cam phaser face.

8. The camshaft assembly as defined in claim 7 wherein the cam nose defines a plurality of peripheral grooves disposed outside of the curvilinear groove.

9. The camshaft assembly as defined in claim 8 wherein the plurality of peripheral grooves are configured to rotationally lock the cam phaser to the cam nose.

10. The camshaft assembly as defined in claim 9 wherein the plurality of peripheral grooves and the curvilinear groove are laser etched onto the cam nose.

11. The camshaft assembly as defined in claim 10 wherein the plurality of peripheral grooves are configured to deform the cam phaser upon engagement between the cam nose and the cam phaser.

12. A camshaft for a vehicle engine, the camshaft comprising:
a camshaft member having a front end and a rear end;
a cam nose disposed at the front end of the camshaft member and adapted to engage with a cam phaser, the cam nose defining a curvilinear groove which surrounds a central axis of the cam nose on a cam nose face; and
a plurality of lobes disposed on the camshaft member between the front end and the rear end.

13. The camshaft as defined in claim 12 wherein the curvilinear groove is configured to prevent oil from leaking away from the central axis upon engagement with the cam phaser.

14. The camshaft as defined in claim 13 wherein the curvilinear groove further includes a curvilinear valley and a curvilinear protrusion formed on each side of the curvilinear valley.

15. The camshaft as defined in claim 14 wherein the curvilinear protrusion on each side of the curvilinear valley is adapted to deform the cam phaser upon engagement between the cam phaser and the cam nose.

16. The camshaft as defined in claim 15 wherein the curvilinear groove is defined on a cam nose face of the cam nose.

17. The camshaft as defined in claim 16 wherein the cam nose defines a plurality of peripheral grooves disposed outside of the curvilinear groove.

18. The camshaft as defined in claim 17 wherein the plurality of peripheral grooves are configured to rotationally lock the cam nose to a cam phaser.

19. The camshaft as defined in claim 18 wherein the plurality of peripheral grooves are configured to deform the cam phaser upon engagement between the cam nose and the cam phaser.
